(19) United States
(12) Patent Application Publication
(10) Pub. No.: US 2005/0001821 A1
(43) Pub. Date: Jan. 6, 2005

(54) Option selector and electronic device including such an option selector

(76) Inventor: Tse How Low, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/612,421

(22) Filed: Jul. 2, 2003

(51) Int. Cl. G09G 5/00

(52) U.S. Cl. 345/169

(57) ABSTRACT

A electronic device (1) comprising a housing (24), a processor (3) and a display screen (5) mounted to the housing (24) and coupled to the processor (3). The electronic device (1) also has a bezel (21) surrounding the display screen (5), the bezel (21) being rotatably mounted to the housing (24). A position detector (26) is operatively coupled to the bezel to provide a signal indicative of a rotational position of the bezel (21) relative to a predetermined datum of the electronic device (1). The position detector (26) is electrically coupled to the processor (3) to permit, by selective rotation of the bezel (21), user selectable options displayed on the display screen (5).

### FIELD OF THE INVENTION

This invention is concerned with displaying and selecting functions of electronic device.

The invention is concerned particularly, although not exclusively, with an option selector for scrolling through a selection of menu options for differing functionalities in a mobile electronic device and for actuation of a selected option.

### BACKGROUND OF THE INVENTION

Of recent times, portable electronic devices such as cellular telephones, laptop computers, personal digital assistants (PDA's), digital wrist watches, remote control devices for audio visual equipment and the like, are adapted for multi-functional operation and typically have a plurality of keys for navigation through a range of option functionalities. Many of these devices possess a screen display with a viewable menu of options navigable by one or more scroll keys.

It is known to manipulate graphics images in a display screen of an electronic device when the image content of a computer program is displayed in windows. If the image content of a window is too great for the display screen, horizontal and vertical scroll bars are provided beside the window to enable the image content to be selectively moved by a pointer device such as a mouse controlled cursor.

Where, in a portable electronic device, there is stored a large volume of contact data such as names, addresses, telephone numbers or the like, it is customary to use a scrollbar or up/down keys to navigate backwards and forwards through individual contacts displayed on a relatively small screen area. With fine granularity control, the up/down keys permit inspection of each record one at a time but this is very slow with a large contact database. A scroll bar on the other hand permits rapid scrolling through contact lists but the coarse granularity of this control causes reduced control with overruns.

It has been proposed to provide a much faster method of scrolling through contact data in devices having a touch sensitive LCD screen where a plurality of menu options and software controlled search function icons are displayed on the screen simultaneously for selection by a stylus tap without having to scroll through menu options and/or contact lists.

In a known display controlled interface between image data stored in the memory of a digital camera and a PC monitor, retrieving and viewing of captured images is assisted by a pair of control buttons to scroll forwards or backwards through images stored in chronological order. Other control buttons are provided for sequential image displays and for turning off the display at the end of the display sequence.

A typical mobile telephone handset these days includes a small display screen and one or more function switching keys combined with up/down buttons to scroll backwards or forwards through options displayed on the screen. A wide range of functionalities can be programmed into such portable electronic devices. Indeed, it is known to provide a telecommunications system having a wireless telephone and a personal computer having a wireless telephone interface. The wireless telephone has a function key to activate PC controlled functionality and permits a menu of options to be transferred to the wireless telephone to allow interaction with a program resident in the PC.

With some electronic devices, the range of options from which to select can be extremely large. For example, a television viewer can be offered hundreds of channels of content from many programming providers via VHF, UHF, microwave and satellite wireless communications as well as fibre optic and copper cable delivery mechanisms. Television channel selectors are arranged linearly in numerical order, say from 1 to 200 and permit viewers to “channel surf” by moving from one channel to another in a linear fashion or by selecting a specified channel. A remote control device for a television receiver typically has a plurality of switching functions operable by a respective key and includes a numeric keypad for selection of a specific channel number or up/down keys for linear channel selections. With the increasing number of channels available and the proliferation of set top “black boxes”, remote control devices typically have a large range of function keys to navigate through the very large range of options available when dealing with so many channel choices. The function keys are typically arranged on the remote control device to permit one-handed operation and may, for example, include a central key surrounded by several concentrically spaced arrays of keys for up/down and left/right option selection.

Remote control devices for video games typically include a plurality of keys to switch between functions and otherwise permit game control. Such remote control devices may also include a joystick and/or a steering wheel for vehicle based games.

While the functionality of portable electronic devices has been increasing rapidly, so too has been the development of progressively smaller devices. In a competitive market, portable electronic devices must these days possess a rich set of features in a compact and stylish housing and yet still exhibit ease of use. This places a considerable constraint on the available screen size and the number of navigational tools available for exploitation of the increased functionality of the device. With a conventional PC or laptop having a relatively large screen display cursor based navigation with a mouse, trackball, joystick or even a full keyboard, screen based navigation of program functionality with scroll bars, tool bars and the like is relatively easy compared with the small screen and limited number of inputs of a hand held electronic device having, say, up/down keys and one to three soft keys.

It has been proposed to increase the functionality of input mechanisms for electronic devices by employing capacitive touch pads having an array of electrodes beneath a touch pad surface whereby movement of a fingertip across the touch pad surface is detected directionally to control screen cursor movement. The touch pad may also include an array of electrodes that are individually actuated in the same manner as a keypad key. The touch pad may have a rectangular array of electrodes having rows and columns representing x and y axes to permit calculation of a finger touch point by an Cartesian co-ordinate system. Other touch pads have circular arrays of electrodes which permit calculation of a finger touch point by a polar co-ordination system. The capacity of these types of touch pads to effect a scrolling function or otherwise to control a screen cursor has permitted the use of a relatively compact input mechanism for certain electronic devices however, the range of functionality is relatively limited compared with other input mechanisms such as a computer mouse, a key pad, touch sensitive LCD screens and the like.

While generally effective for their respective intended uses, most of the navigation systems described above have one or more limitations which effectively preclude their use in one or more portable electronic devices.

### BRIEF SUMMARY OF THE INVENTION

According to one aspect of the invention there is provided an option selector for an electronic device. The option selector has a bezel surrounding a display screen of the electronic device, the bezel being rotatably mounted to a housing of the electronic device. The selector has a position detector operatively coupled to the bezel to provide a signal indicative of a rotational position of the bezel relative to a predetermined datum on said electronic device. The position detector is electrically coupled to a processor of the electronic device to permit, by selective rotation of the bezel, user selectable options displayed on the display screen.

According to another aspect of the invention there is provided electronic device comprising a housing, a processor and a display screen mounted to the housing and coupled to the processor. The electronic device also has a bezel surrounding the display screen, the bezel being rotatably mounted to the housing. A position detector is operatively coupled to the bezel to provide a signal indicative of a rotational position of the bezel relative to a predetermined datum of the electronic device. The position detector is electrically coupled to the processor to permit, by selective rotation of the bezel, user selectable options displayed on the display screen.

Throughout this specification and claims which follow, unless the context requires otherwise, the word comprise, and variations such as comprises or comprising, will be understood to imply the inclusion of a stated integer or group of integers or steps but not the exclusion of any other integer or group of integers.

### BRIEF DESCRIPTION OF THE DRAWINGS

In order that the invention may be more fully understood and put into practical effect, reference will now be made to preferred embodiments illustrated in the accompanying drawings in which:—

FIG. 1 shows schematically a portable electronic device incorporating the invention;

FIG. 2 shows a part cutaway view of one form of a controller mechanism;

FIG. 3 is a cross-sectional view through 3-3 in FIG. 2;

FIG. 4 shows a part cutaway view of an alternative form of a controller mechanism;

FIG. 5 is a cross-sectional view through 5-5 in FIG. 4;

FIG. 6 is a cross-sectional view of yet another controller mechanism shown in the same direction as section B-B in FIG. 4; and

FIG. 7 is a view of a cellular telephone embodying the invention.

### DETAILED DESCRIPTION OF THE DRAWINGS

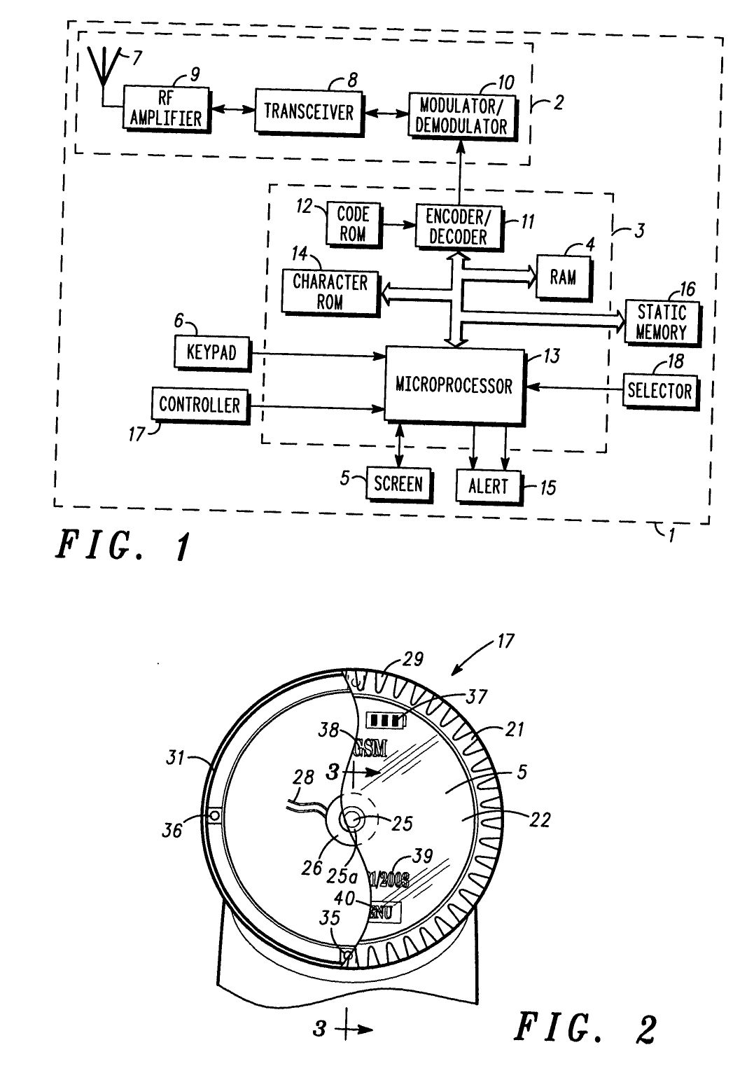

With reference to FIG. 1 there is illustrated an electronic device 1 comprising a radio frequency communications unit 2 coupled to be in communication with a processor 3. An input interface in the form of a display screen 5 (typically a Liquid Crystal Display) and a keypad 6 are also coupled to be in communication with the processor 3.

The processor 3 includes an encoder/decoder 11 with an associated Read Only Memory (ROM) 12 storing data for encoding and decoding voice or other signals that may be transmitted or received by electronic device 1. The processor 3 also includes a microprocessor 13 coupled to both the encoder/decoder 11 and an associated character Read Only Memory (ROM) 14. Microprocessor 13 is also coupled to a Random Access Memory (RAM) 4, a pointer movement controller 17, a selector 18 and a static programmable memory 16.

Auxiliary outputs of microprocessor 13 are coupled to an alert module 15 that typically contains a speaker, vibrator motor and associated drivers. The character Read Only Memory 14 stores code for decoding or encoding text messages that may be received by the communication unit 2, input at the keypad 6. In this embodiment the character Read Only Memory 14 also stores operating code (OC) for microprocessor 13. The operating code (OC) is used to run applications on the electronic device 1.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

The electronic device 1 can be any electronic device including a cellular telephone, a conventional type telephone, a laptop computer or a PDA. The pointer movement controller 17 provides for controlling a position of a pointer (not shown) and movement of the pointer on the screen 5 and typically may be used to scroll through a range of optional functions or stored data such as contact information. Also, the selector 18 provides for selecting areas of text, icons and the like displayed on the screen 5 and pointed to by the screen pointer. As will be apparent to a person skilled in the art, typically if the selector 18 selects an icon on the screen 5, pointed to by the pointer, this will invoke a function controlled by processor 3.

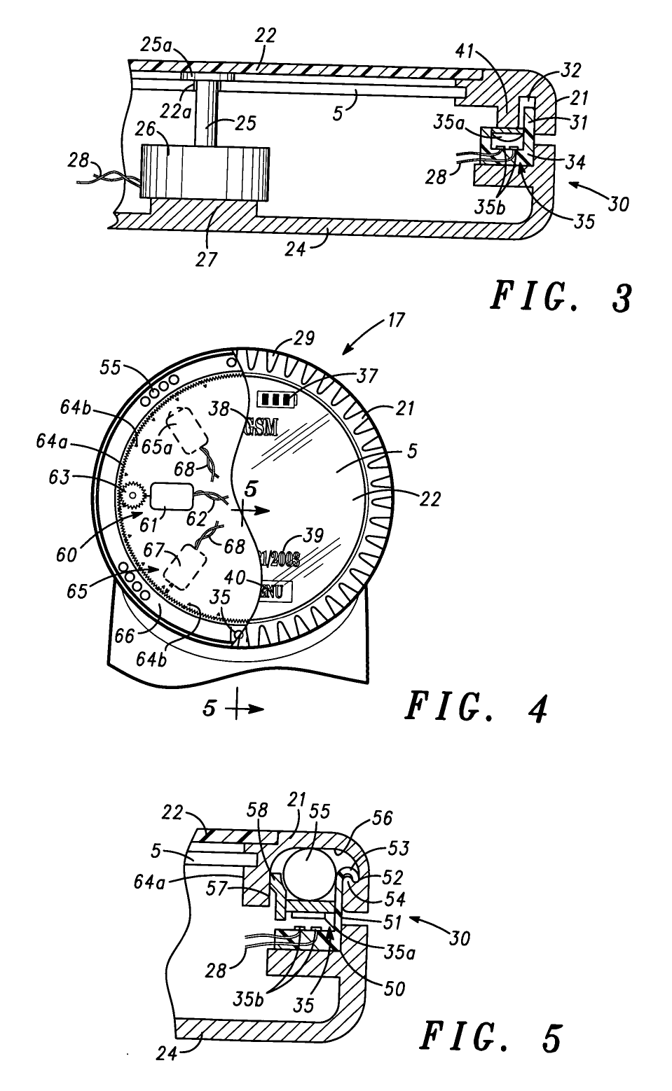

Referring now to FIGS. 2 and 3, there is illustrated in a part cutaway view a controller mechanism as embodied in a cellular telephone 30 typically of the type shown in FIG. 7.

For the sake of simplicity, like reference numerals are employed for like features throughout the accompanying drawings.

In FIGS. 2 and 3 there is shown one embodiment of an option selector for an electronic device, the selector includes the pointer movement controller 17 in the form of an annular bezel 21 supporting a protective glass or plastics window 22 through which the display screen 5 (that is circular in this embodiment) is viewable. Hence, the bezel 21 of the controller 17 surrounds the display screen 5. The Controller 17 is bi-directionally rotatably mounted with respect to a housing or body 24 of the cellular telephone 30 by a shaft 25 having a mounting flange 25a at one end adhesively attached to window 22. The other end of shaft 25 is coupled to a position detector in the form of a servo generator or stepping generator 26 that in turn is mounted on a base 27 forming part of the body 24 of the cellular telephone 30. The position detector is therefore operatively coupled to the bezel 21 to provide a signal indicative of a rotational position of the bezel 21.

The shaft 25 extends through an aperture 22a in display screen 5 (or the screen 5 may be a formed from two sections separated by a small gap through which extends the shaft 25). Also, the shaft 25 has an axis of rotation common with bezel 21 and electrical conductors 28 couple the generator 26 to a processor 3 to provide a user controlled pointer or scrolling function in response to rotation of the bezel 21.

Bezel 21 includes a contoured surface in the form of spaced notches 29 to assist a user in rotating the bezel about an annular track 31.

As shown more clearly in FIG. 3, bezel 21, which may be typically of metal or plastics material includes an annular slotted aperture 32 that locates over the track 31. The lower part of track 31 is formed as a U-shaped channel 34 that contains one or more electrical selectors 18 in the form of switch mechanisms 35, 36 located about the circumference of channel 34.

In use, with the circular telephone 30 switched on, the display screen 5 will display various icons or indicia such as a battery state 37, radio communications frequency or mode 38, date 39 and a menu sign 40 adjacent electrical selector switch 35. By pressing down on the bezel 21 in the region of the menu sign 40, an annular wall member 41 on the underside of bezel 21 urges electrical selector switch 35 to close (by a contact plate 35a bridging switch contacts 35b) as the bezel/window combination 21/22 is tilted by resiliently deforming base 27 upon which the generator 26 is mounted. Actuation of selector switch 35 causes a list of menu options to be displayed upon the display screen 23 and by rotating bezel 21 either clockwise or counter-clockwise a user is able to scroll up or down the displayed menu options. When a desired option is located, selector switch 35, or another selector switch such as switch 36, is closed (actuated) to invoke the selected function. In this regard, the switch 36 is actuated by movement of a section of the bezel 21 towards the housing or body 30.

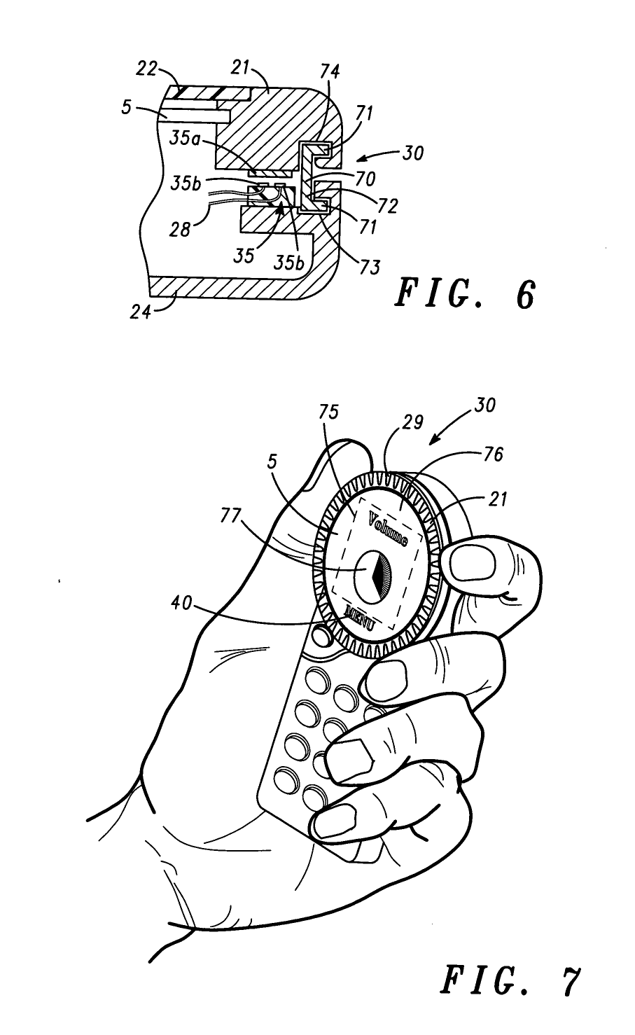

Referring to FIGS. 4 and 5 there is illustrated alternative preferred option selector embodiments. As shown, the bezel 21 is formed as a concentric ring that rotates about a circular display screen 5 which is rigidly mounted in the housing or body 24 of the telephone 30. Bezel 21 is rotatably secured to body 24 of the telephone 30 by an annular track assembly 50 in the form of a U-shaped channel 51. An outer flange 52 is down-turned to form an inverted channel 53 which slidingly locates an upturned inner edge portion 54 of bezel 21. Selector switch 35 is located in the channel 51 and resting on an upper switch contact member 35a is a ball bearing 55 contacting an inner wall 56 of bezel 21. An inner wall 57 of bezel 21 slidingly engages against inner flange 58 of channel 51.

As shown in FIG. 4, the controller 17 that generates controller signals includes an electromechanical position detector in the form of a gear driven signal generator 60 having a gear drive coupled to an electrical signal generator 61, in turn coupled to the processor 3 via electrical conductors 62. A gear wheel 63 engages with inwardly protruding teeth 64a on an innermost circumference of bezel 21 outer flange 52 of channel 51. An alternative mechanical signal generator 65 is shown in phantom with an actuating arm 66 pivoted to an electrical switch housing 67 that is electrically coupled to the processor 3 by electrical conductors 68. Actuating arm 66 is bi-directional in that regardless of the direction of bezel 21, contact between teeth 64b (an innermost circumference of bezel 21) and the end of arm 66 causes deflection of arm 66 and provides a bi-directional pulsed signal to be sent to the processor 3. This signal is indicative of a degree of rotation of bezel 21 due to the signal providing positive or negative sequences of pulses counts.

Yet another alternative the position detector is an opto-electrical sensor 65a also shown in phantom. Sensor 65a is configured to read and count markings or graduations (not shown) around a lower inner part of inner flange 58 of track assembly 50 and to transmit, via electrical conductors 28, electrical signals indicative of the extent of rotation of bezel 21 (rotational position) relative to a datum point of the electronic device 30. Ball bearings 55 distributed about the interior channel 51 of track assembly 50 assist in providing a smooth, friction-free rotational feel to bezel 21.

The scrolling function of bezel 21 is substantially identical to that described with reference to FIGS. 2 and 3 in that electromechanical generator 60 or mechanical signal generator 65 or sensor 65 each transmit signals to the processor 3 in response to the degree of selective rotation of bezel 21 from a predetermined datum position. This allows for one or more options displayed on a display screen that may be selected by a user. Selector switch 35 however is actuated by the application of finger pressure to the top of bezel 21 towards the inner wall 57 thereof. In the embodiment shown, bezel 21 is formed from a semi-rigid plastics material which permits limited resilient deformation of the bezel sufficient to urge ball bearing 55 into contact with the upper switch contact member 35a and in turn to urge contact member 35a to close electrical switch 35.

FIG. 6 shows yet another alternative embodiment of bezel mounting with an associated electrical switch. In the embodiment shown, bezel 21 is supported for rotation on an annular metallic track member 70 comprising a pair of spaced outwardly projecting flanges 71 extending about the opposite edges of an annular web 72. Track 70 is captively retained in the body 24 of the electronic device 30 by engagement of lower flange 71 in a slotted aperture 73 and bezel 21 is captively retained by engagement of upper flange 71 in a slotted aperture 74. Both bezel 21 and body 24 are chosen from a semi-rigid plastics material with self-lubricating qualities to permit bezel 21 to rotate relative to track 70, or to allow track 70 to rotate relative to body 24 or alternatively, each of track 70, bezel 21 and body 24 to rotate, at least partially, relative to each other. Bezel 21, although comprising a substantially solid member, is sufficiently resiliently deformable to enable actuation of selector switch 35 by finger pressure on the bezel to bring switch contact plate 35a into a bridging contact with switch contacts 35b supported on body 24.

FIG. 7 illustrates an embodiment of the cellular telephone 30 embodying the invention. The cellular telephone 30, houses the electrical circuitry of FIG. 1, and comprises a circular display screen 5 or at least a rectangular screen (shown in phantom at 75) with a circular border or margin 76. After actuating an electrical switch (not shown) by applying finger pressure to bezel 21 adjacent the “menu” sign 40, an initial range of menu options appears on display screen 23 and a user is able to scroll through those options by rotating bezel 21 in a clockwise or anticlockwise direction until a screen pointer (not shown) identifies a selected option. The selector switch (not shown) is then actuated by application of finger pressure to the bezel 21 adjacent the menu sign 40 to invoke the menu selection, for example, speaker volume, whereupon an icon 77 graphically representing current speaker volume and volume range appears. By rotating bezel 21 either with a thumb 78, a forefinger 79 or both thumb and forefinger, the speaker volume may be increased or decreased from a preset level as required. Once the desired volume level has been attained, the selector switch is again actuated to lock the selected value into the memory (not shown) of the cellular telephone 30.

It readily will be apparent to persons skilled in the art that the option selector of the present invention and portable electronic devices embodying the selector possess substantial advantages over the prior art.

By providing a rotary mechanism for scrolling functions, a large number of items such as telephone or contact lists can be scanned very quickly. At the same time, the capacity to operate the rotary bezel controller with either the thumb or forefinger or both allows a very high degree of precision in making a selection from rapidly scrolled data. Unlike some prior art electronic devices, the configuration possible with the present invention is equally suitable both to right-handed and left-handed users without any bias towards one group of users.

Another significant advantage which accrues from the present invention is that its configuration is ideally suited to more compact devices without any sacrifice as to ease and convenience of use. By placing the bezel around the display screen of the device, no additional space is required on the front of the device body to accommodate the scrolling controller, on the contrary, the invention permits at least the up and down keys to be removed from the keypad if required.

When embodied in a cellular telephone, the telephone may be programmed such that in the course of a telephone call, the volume adjustment mode may be invoked whereupon a user may adjust volume during use without interrupting a conversation and without having to move the device into a field of view to make such an adjustment.

It also will be apparent to a person skilled in the art that a rotational pointer movement controller or scroller can facilitate far greater functionality of portable electronic devices whilst combining ease and convenience of use. For example, the rotational scroller may permit a zoom in/zoom out function for an inbuilt digital camera or with photo or video graphics, selection of font size and type, adjustment of ring tone level and the like. In particular, for game applications, the rotational controller may act as a directional controller such as a steering wheel or even a tuner for in-built radio functionality.

The detailed description provides preferred exemplary embodiments only, and is not intended to limit the scope, applicability, or configuration of the invention. Rather, the detailed description of the preferred exemplary embodiments provide those skilled in the art with an enabling description for implementing preferred exemplary embodiments of the invention. It should be understood that various changes may be made in the function and arrangement of elements without departing from the spirit and scope of the invention as set forth in the appended claims.

1. An option selector for an electronic device, said option selector comprising:—
a bezel surrounding a display screen of said electronic device, said bezel being rotatably mounted to a housing of said electronic device; and
a position detector operatively coupled to said bezel to provide a signal indicative of a rotational position of said bezel relative to a predetermined datum of said electronic device, said position detector being electrically coupled to a processor of said device to permit, by selective rotation of said bezel, user selectable options displayed on said display screen.

2. An option selector as claimed in claim 1 wherein said controller is bi-directionally rotatable.

3. An option selector as claimed in claim 1 wherein the bezel is annular.

4. An option selector as claimed in claim 2 wherein the bezel is mounted on an annular track of said housing.

5. An option selector as claimed in claim 1 wherein the position detector is operatively coupled to the bezel by a rotatable shaft having an axis of rotation common with the bezel.

6. An option selector as claimed in claim 1 wherein the position detector is operatively coupled to the bezel by a gear drive.

7. An option selector as claimed in claim 1 wherein the position detector is operatively coupled to the bezel by opto-elctrical coupling.

8. An option selector as claimed in claim 1 wherein the controller includes a contoured surface to assist user rotation thereof.

9. An option selector as claimed in claim 1 wherein said controller is mechanically coupled to at least one selector switch to permit activation of one of said options.

10. An option selector as claimed in claim 9 wherein said controller selector switch is activated in use by movement of at least a section of said bezel towards said housing.

11. An electronic device comprising:
a housing;
a processor;
a display screen mounted to said housing and coupled to the processor;
a bezel surrounding the display screen, said bezel being rotatably mounted to the housing; and
a position detector operatively coupled to said bezel to provide a signal indicative of a rotational position of said bezel relative to a predetermined datum of said electronic device, said position detector being electrically coupled to the processor to permit, by selective rotation of said bezel, user selectable options displayed on said display screen.

12. An electronic device as claimed in claim 11 wherein said controller is bi-directionally rotatable.

13. An electronic device as claimed in claim 11 wherein the bezel is annular.

14. An electronic device as claimed in claim 13 wherein the bezel is mounted on an annular track of said housing.

15. An electronic device as claimed in claim 11 wherein the position detector is operatively coupled to the bezel by a rotatable shaft having an axis of rotation common with the bezel.

16. An electronic device as claimed in claim 11 wherein the position detector is operatively coupled to the bezel by a gear drive.

17. An electronic device as claimed in claim 11 wherein the position detector is operatively coupled to the bezel by opto coupling.

18. An electronic device as claimed in claim 11 wherein the controller includes a contoured surface to assist user rotation thereof.

19. An electronic device as claimed in claim 11 wherein said controller is mechanically coupled to at least one selector switch to permit activation of one of said options.

20. An electronic device as claimed in claim 19 wherein said controller selector switch is activated in use by movement of at least a section of said bezel towards said housing.
